(19) United States
(12) Patent Application Publication
(10) Pub. No.: US 2012/0173292 A1
(43) Pub. Date: Jul. 5, 2012

(54) RESERVABLE ELECTRIC VEHICLE CHARGING GROUPS

(76) Inventors: James Solomon, Saratoga, CA (US); Milton T. Tormey, Los Altos, CA (US); Praveen K. Mandal, Los Altos Hills, CA (US); Richard Lowenthal, Cupertino, CA (US); Harjinder Bhade, San Jose, CA (US)

(21) Appl. No.: 12/985,317

(22) Filed: Jan. 5, 2011

(51) Int. Cl. G06Q 10/00

(52) U.S. Cl. 705/5

(57) ABSTRACT

An electric vehicle charging network server establishes electric vehicle charging reservation groups. The electric vehicle charging network server is coupled with multiple electric vehicle charging stations that each include one or more charging ports and are owned by a charging station host. The server receives input from the charging station host to configure an electric vehicle charging reservation group. The server configures the electric vehicle charging reservation group according to the received input. The configured electric vehicle charging reservation group includes multiple charging ports and allows a limited number of electric vehicle charging group reservations that are each applicable to all of the charging ports that are part of the configured electric vehicle charging reservation group.

### FIELD

Embodiments of the invention relate to the field of charging electric vehicles; and more specifically to reservable electric vehicle charging groups.

### BACKGROUND

Electric vehicle charging stations provide charging points for electric vehicles (e.g., electric battery powered vehicles, gasoline/electric battery powered vehicle hybrids, etc.). Charging stations may be located in designated charging locations (e.g., similar to a gas station), near or associated with parking spaces (e.g., public parking spaces and/or private parking space), or other locations.

Although more and more electric vehicle charging stations are being installed, the availability of certain charging stations in a given location may be limited and may not be enough to meet demand. As a result, electric vehicle operators may, during periods of high demand, experience difficulty in locating an electric vehicle charging station that is available for charging. There are tools that exist that allow electric vehicle operators (e.g., drivers of electric vehicles or other users associated with the electric vehicles) to determine whether electric vehicle charging station(s) in a given location are currently being used.

### SUMMARY

Reservable electric vehicle charging groups is described herein. In one embodiment, an electric vehicle charging network server establishes electric vehicle charging reservation groups. The electric vehicle charging network server is coupled with multiple electric vehicle charging stations that each include one or more charging ports and are owned by a charging station host. The server receives input from the charging station host to configure an electric vehicle charging reservation group. The server configures the electric vehicle charging reservation group according to the received input. The configured electric vehicle charging reservation group includes multiple charging ports and allows a limited number of electric vehicle charging group reservations that are each applicable to all of the charging ports that are part of the configured electric vehicle charging reservation group.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary electric vehicle charging station network for establishing and using electric vehicle charging group reservations according to one embodiment of the invention;

FIG. 2 is a flow diagram illustrating exemplary operations for a host to configure (e.g., create and/or edit) one or more charging reservation groups according to one embodiment;

FIG. 3 is a flow diagram illustrating exemplary operations for making a charging group reservation according to one embodiment;

FIG. 4 is a flow diagram illustrating exemplary operations related to an electric vehicle operator using a charging station in conjunction with a charging group reservation and/or making a charging group reservation according to one embodiment;

FIG. 5 is a flow diagram illustrating exemplary operations for extending charging group reservations according to one embodiment;

FIG. 6 is a flow diagram illustrating exemplary operations for cancelling a charging group reservation according to one embodiment; and

FIG. 7 illustrates an exemplary embodiment of a charging station according to one embodiment of the invention.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

A method and apparatus for reservable electric vehicle charging groups is described. In one embodiment, an electric vehicle charging reservation group includes multiple charging ports and is configured to accept a limited number of reservations for electric vehicle operators that are each applicable to those charging ports in the electric vehicle charging reservation group. A charging port is a connection on a charging station to which an electric vehicle can be attached. For example, some charging stations may include one or more charging ports that are power receptacles (e.g., power receptacle(s) conforming to NEMA (National Electrical Manufacturers Association) standards 5-15, 5-20, 14-50 or other standards (e.g., BS 1363, CEE7, etc.) that may be operating at different voltages (e.g., 120V, 240V, 230V, etc.)) that are configured to accept plugs of a charging cord and/or include one or more charging ports that have an attached charging cord having a standard connector for charging electric vehicles (e.g., SAE J1772). The charging port(s) on a charging station can be used independently. For example, one electric vehicle can be plugged into a power receptacle while the standard connector (e.g., SAE J1772 connector) can be plugged into another electric vehicle.

In one embodiment, an electric vehicle charging group reservation is charging port agnostic such that the reservation allows the electric vehicle operator to use any available charging port of an electric vehicle charging station in the corresponding reservation group. For example, an electric vehicle operator makes a reservation for a particular reservation group that allows the electric vehicle operator to use any of the charging ports of the electric vehicle charging stations of that reservation group that are available.

In one embodiment, a charging station host configures a charging reservation group to include one or more electric vehicle charging stations, which typically belong to that host, and their respective charging ports. In one embodiment, the charging station host specifies the charging port(s) that are to be part of the charging reservation group. In another embodiment, the charging station host specifies the electric vehicle charging station(s) that are to be part of the charging reservation group and the charging port(s) of those charging station(s) are automatically part of the charging reservation group.

In one embodiment, a charging reservation group includes come-and-go privileges. A come-and-go privilege allows an electric vehicle operator to come-and-go from the members of the charging reservation group at will for the duration of the reservation. For example, after making a come-and-go privilege reservation, an electric vehicle operator can bring their electric vehicle to an available charging port of an electric vehicle charging station for charging, subsequently leave the charging station (e.g., unplug from the charging port and drive the electric vehicle to another location), and sometime later during the reservation, bring the electric vehicle back to the charging port of the charging station (or other available charging port of the come-and-go privilege group) for further charging.

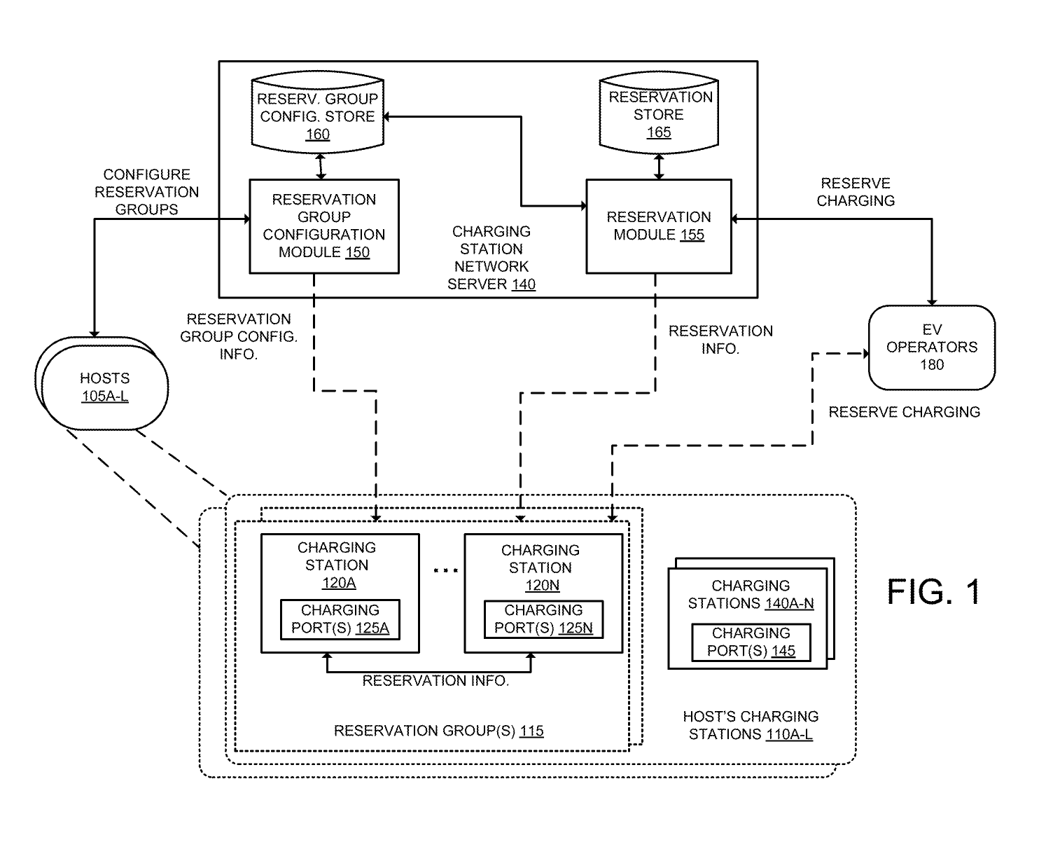

FIG. 1 illustrates an exemplary electric vehicle charging station network for establishing and using electric vehicle charging group reservations according to one embodiment of the invention. The charging station host(s) 105A-L own or control a group of charging stations 110A-110L respectively and may also own or control parking spaces associated with the charging stations 110A-110L. The hosts 105A-L may be a corporation, a utility, a government, an apartment/condo owner, or other entity that owns or controls the group of charging stations 110A-110L respectively. The group of charging stations 110A-110L include charging stations that provide charging service for electric vehicles. That is, the charging stations within the group of charging stations 110A-110L can provide charging service for the electric vehicles of the electric vehicle operators 180. Each of the charging stations includes one or more charging ports (e.g., one or more power receptacles and/or one or more attached charging cords having a standard connector).

In one embodiment, a charging session is established to charge an electric vehicle and account for energy transferred during the charging session. A charging session is a logical period of time during which energy can be transferred between an electric vehicle and a power grid through a charging port of a charging station. The direction of the energy transfer may be from the power grid to the electric vehicle, or from the electric vehicle to the power grid (vehicle-to-grid (V2G)). In one embodiment, a charging session is established after an electric vehicle operator is authorized.

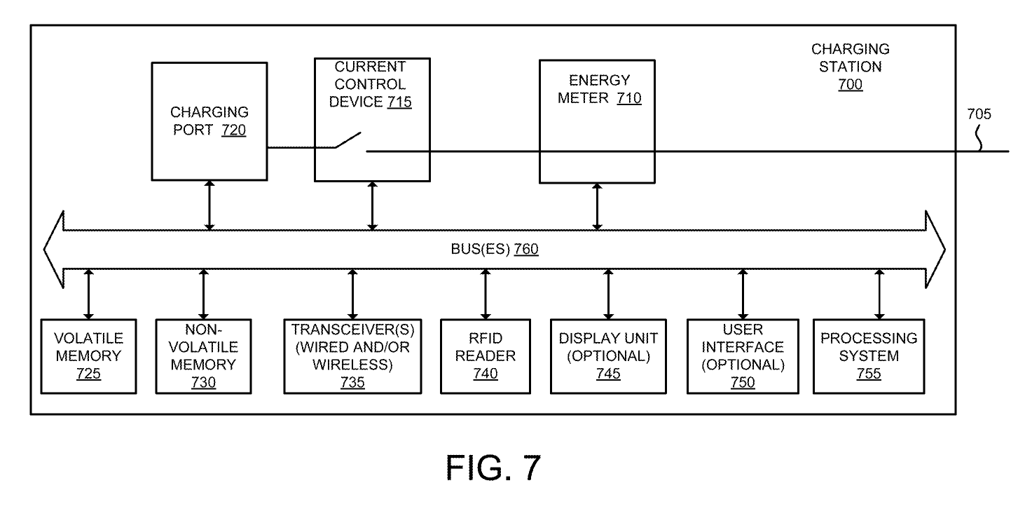

In some embodiments, each of the charging stations in the group of charging stations 110A-110L include control circuitry to energize and de-energize its charging port(s) to allow current to flow between an electric vehicle and a power grid. In such embodiments, the charging port(s) of a charging station are de-energized when not being used and are energized after a user is authorized to allow charging. In one embodiment, each of the charging stations also includes a meter to measure the amount of energy being transferred between an electric vehicle and a power grid during a charging session. FIG. 7, which will be described later herein, illustrates an exemplary charging station in more detail according to one embodiment.

In one embodiment, each of the charging stations is networked with the charging station network server 140 (hereinafter server 140). The charging stations can send messages to the server 140 and receive messages from the server 140 (the messages may be sent and/or received directly or indirectly through one or more other network devices). The server 140 may be owned and administered by a different entity than at least one of the hosts 105A-105L (thus a host may own or operate the server 140). The charging stations may communicate with the server 140 over different types of communication links (e.g., a cellular link (e.g., CDMA, GPRS, etc.), WiFi internet connection, Plain Old Telephone Service (POTS), leased line, Bluetooth, ZigBee, Ethernet, PLC (Power Line Communication), etc.). Although not illustrated in FIG. 1, in some embodiments one or more of the charging stations communicate with the server 140 indirectly through a gateway device, which may be a different one of the charging stations.

In one embodiment, the server 140 provides electric vehicle charging reservation service for the hosts 105A-L and the electric vehicle operators 180. For example, the hosts 105A-L use the reservation group configuration module 150 to configure (create and/or edit) one or more charging reservation groups including configuring a reservation group profile for each of the reservation groups. In one embodiment the hosts 105A-L access the reservation group configuration module 150 through the Internet using a web browser or through specialized application software that connects with the charging station network server (e.g., an application on a smartphone).

The reservation group configuration data store 160 stores the reservation group profiles for the reservation groups. Each configured reservation group profile indicates one or more of the following for the corresponding reservation group: the charging port(s) that belong to that reservation group; the electric vehicle charging station(s) that belong to that reservation group; the number of reservations supported by that reservation group; whether over-reservation is allowed (and the amount of allowed over-reservation); the duration of a reservation (e.g., X number of hours) for that reservation group; the minimum and/or maximum duration of a reservation that can be requested by electric vehicle operators and set; the pricing for reservations for that reservation group, which may vary by operator or group of operators, date, time of day, and/or pricing method (e.g., flat-fee, per-hour, per-kWh), have a minimum and/or maximum price, and/or include a separate fee for the reservation (e.g., flat-fee or per-unit-of-time) in addition to any energy consumed or single fee that includes a fee for the reservation and energy consumption (e.g., per-kWh); a cancel interval that indicates an amount of time before the reservation is set to begin before which the electric vehicle operator can cancel the reservation without penalty, a cancellation penalty amount that indicates a monetary amount for a cancellation of a reservation; information that indicates which electric vehicle operators are allowed to make a charging group reservation for the reservation group (e.g., a list of electric vehicle operator identifier(s) that are allowed to make a reservation and/or a list of electric vehicle operator identifier(s) that are not allowed to make a reservation); whether the reservation group supports come-and-go privileges.

Over-reservation refers to allowing more reservations for a particular reservation group than can be fulfilled at a single time in that reservation group. For example, over-reservation allows N electric vehicle operators to reserve M charging ports of a reservation group, where M is less than N. Over-reservation allows a charging station host to take advantage of the fact that there may be a certain percentage of electric vehicle operators that do not show up either on-time for a reservation or do not show up at all during the reservation. In one embodiment, the charging station network server monitors the reservation history about a particular charging group including monitoring the number of reservations made for that group that are not used. The charging station network server can calculate a percentage of likely no-shows for the charging group based on monitored history data (which may be different on different days/times), which can be provided and used by the charging station hosts when determining whether to use over-reservation for a particular charging group and the amount of over-reservation.

In some embodiments, the server 140 transmits reservation group configuration information to appropriate ones of the charging stations. For example, for a particular charging reservation group, the server 140 transmits reservation group configuration information to all of the charging stations of that charging reservation group. The reservation group configuration information may include the same information as included in the corresponding reservation profile or a subset of the information of the corresponding reservation profile, and may also include additional information. For example, the reservation group configuration information may include one or more of the following: the number of reservations supported by that reservation group; the pricing for the reservation group; a list of identifiers (e.g., charging station serial numbers) for those charging stations that are part of the reservation group; information that indicates how to communicate with the charging stations that are part of the reservation group (e.g., the IP addresses of the charging stations); a list of identifiers that indicate which electric vehicle operators are allowed to make a reservation of the charging reservation group; and whether come-and-go privileges are supported for the reservation group.

As illustrated in FIG. 1, each of the group of charging stations 110A-L includes the charging stations 120A-120N that are configured to be part of a charging reservation group 115 and the charging stations 140A-140N that are not part of a reservation group. The charging stations 120A-120N include the charging port(s) 125A-125N respectively. The charging stations 140A-140N each include the charging port(s) 145. The charging stations 120A-120N are typically physically near each other (e.g., included in the same parking structure, parking lot, neighborhood, etc.), but this is not a requirement as some hosts may configure a reservation group to include charging stations that are not substantially physically close to one another.

While FIG. 1 illustrates each of the hosts 105A-105L having multiple charging stations that are part of reservation group and multiple charging stations that are not part of a reservation group, it should be understood that this is exemplary as a host may configure only a single reservation group that may only include a single charging station (possibly with multiple charging ports) and/or not have any charging stations that are not part of a reservation group.

The electric vehicle operators 180 use the reservation module 155 to make electric vehicle charging group reservations that allow the electric vehicle operators 180 to reserve use of a charging port of that charging reservation group that allows those operators to use any available charging port of the group, extend existing charging group reservations, and/or cancel existing charging group reservations. The charging group reservations are charging port agnostic meaning that a charging group reservation allows an electric vehicle operator to reserve use of a charging port of that charging reservation group and that reservation is applicable to any of the charging ports of that charging reservation group. Thus, the reservation is not specific to a charging port, but rather is generally applicable to all of the charging ports of the charging reservation group. For example, consider a charging reservation group that has been configured by a host to include multiple charging ports of multiple charging stations in the same parking lot. In general, an electric vehicle operator does not care which charging port to use, only that a charging port is available to use. An electric vehicle operator can use the reservation module 155 to reserve use of a charging port in that parking lot that is applicable to any of the charging ports. When the electric vehicle operator brings their electric vehicle to the parking lot, the vehicle operator can use any of the available charging ports. In one embodiment the electric vehicle operations 180 access the reservation module 155 through the Internet using a web browser or through specialized application software that connects with the charging station network server (e.g., an application on a smartphone).

The reservation data store 165 stores information that defines the charging group reservations. For example, the reservation information stored in the reservation data store 165 includes, for each charging group reservation, one or more of the date and time of the reservation, an identifier of the charging reservation group, an identifier associated with the electric vehicle operator belonging to the reservation, the pricing to apply to the reservation, and whether the reservation includes come-and-go privileges. In one embodiment the server 140 transmits reservation information to the appropriate charging stations. For example, for a particular charging reservation group, the server 140 transmits reservation information to all of the charging stations of that charging reservation group. The reservation information allows the charging stations in the reservation group to, among other things, determine whether to grant a charging session request received from an electric vehicle operator (e.g., by determining whether that electric vehicle operator is associated with a valid charging group reservation). In one embodiment, the reservation information includes, for each charging group reservation, one or more of the date and time of the reservation, an identifier associated with the electric vehicle operator belonging to the reservation, the pricing scheme to apply to the reservation, and whether the reservation includes come-and-go privileges.

In some embodiments the electric vehicle operators 180 can request a charging group reservation directly through an electric vehicle charging station or other device near the electric vehicle charging station (e.g., at a payment station coupled with the electric vehicle charging station). In some embodiments the electric vehicle operators 180 can request charging group reservation differently (e.g., by calling and speaking to an operator to request a charging group reservation, by sending an email or text message to request a charging group reservation, etc.).

In addition to providing reservation services, the server 140 may also provide other services on behalf of the hosts 105A-L and/or the electric vehicle operators 180 including authentication/authorization (e.g., performing an authorization procedure to determine whether an electric vehicle operator is authorized to use a particular charging station), payment services including billing/invoicing to account for energy being transferred during a charging session, notification services to cause notification messages (e.g., text message, email message) to be sent to electric vehicle operators upon certain events occurring, and other services related to charging electric vehicles.

While FIG. 1 illustrates the reservation group configuration module 150 being on the same server as the reservation module 155, the invention is not so limited as the reservation group configuration module 150 and the reservation module 155 can be located on separate servers.

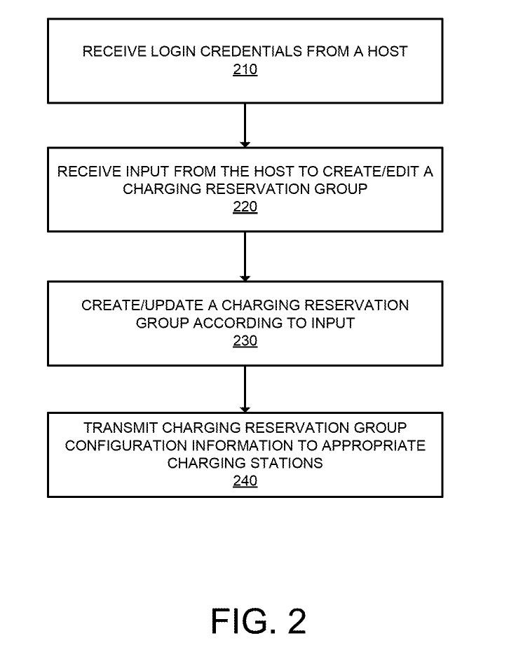

FIG. 2 is a flow diagram illustrating exemplary operations for a host to configure (e.g., create and/or edit) one or more charging reservation groups according to one embodiment. The operations of FIG. 2 will be described with reference to the exemplary embodiment of FIG. 1. However, it should be understood that the operations of FIG. 2 can be performed by embodiments of the invention other than those discussed with reference to FIG. 1, and the embodiments discussed with reference to FIG. 1 can perform operations different than those discussed with reference to FIG. 2.

At operation 210, the server 140 receives login credentials from a particular host 105 and logs the host 105 into the server 140. In one embodiment, the hosts 105A-L are registered for service with the server 140 including registering their charging station(s) with the server 140. The registration allows the host to provide contact information (e.g., name, company, address, email address(es), telephone number(s)) and information identifying their charging stations (e.g., charging station serial numbers, etc.). A third party may also register the charging stations on behalf of the host. After logging in to the server 140, the host 105 can view status regarding their charging station(s), including the present status of their charging station(s) (e.g., charging, available, out-of-service), reports on occupancy rates of their charging station(s), reports on energy usage for each of their charging station(s), etc. Flow moves from operation 210 to operation 220.

At operation 220, the reservation group configuration module 150 receives input from the host 105 to configure a charging reservation group (e.g., create a charging reservation group or edit an existing charging reservation group). The input may indicate one or more of the following: the charging port(s) that are to belong to the reservation group, the electric vehicle charging station(s) that are to belong to that reservation group; whether over-reservation is allowed (and the amount of allowed over-reservation); the duration of a reservation (e.g., X number of hours) for that group; the minimum and/or maximum duration of a reservation that can be requested by electric vehicle operators and set; the pricing for reservations for that reservation group, which may vary by operator or group of operators, date, time of day, and/or pricing method (e.g., flat-fee, per-hour, per-kWh), have a minimum and/or maximum price, and/or include a separate fee for the reservation (e.g., flat-fee or per-unit-of-time) in addition to any energy consumed or single fee that includes a fee for the reservation and energy consumption (e.g., per-kWh); a cancel interval that indicates an amount of time before the reservation is set to begin before which the electric vehicle operator can cancel the reservation without penalty, a cancellation penalty amount that indicates a monetary amount for a cancellation of a reservation; information that indicates which electric vehicle operators are allowed to use the electric vehicle charging station(s) of the reservation group (e.g., a list of electric vehicle operator identifier(s) that are allowed to use the charging station(s) and/or a list of electric vehicle operator identifier(s) that are not allowed to use the charging station(s)); and whether the reservation group supports come-and-go privileges. Flow moves from operation 220 to operation 230.

In some embodiments, the host 105 can configure the price for a charging group reservation based on several different pricing options and settings. For example, the hosts can establish a price per duration of the reservation (e.g., one price regardless of the amount of electricity consumed during any charging during that reservation); per charging session (there may be one or more charging sessions during the duration of the reservation) with an extra fee for the reservation; or per amount of energy transferred, either consumed from a power grid or supplied to a power grid in a vehicle-to-grid (V2G) case, (e.g., kilowatt-hour (KWh)) during the charging session(s) with an extra fee for the reservation. A host 105 can also define the pricing to be dependent on the time and/or date. For example, daytime charging may have different price(s) than overnight charging, weekday charging may have different price(s) than weekend charging, holiday charging may have different price(s) than non-holidays, etc. A host 105 can also define the pricing differently for different electric vehicle operators. For example, the host 105 can define pricing such that some electric vehicle operators are exempt from payment, some electric vehicle operators are required to pay a surcharge, some electric vehicle operators pay a reduced rate, etc., for one or more members of their charging reservation groups. In addition, the host 105 can also define the pricing such that the reservation fee is separate than the fees for energy consumption during the reservation or included within the fees for energy consumption.

At operation 230, the reservation group configuration module 150 configures the charging reservation group (creates the charging reservation group or updates an existing charging reservation group) according to the input provided by the host 105. The configured charging reservation group includes one or more charging ports of one or more charging stations and allows a limited number of charging group reservations at a particular time that are each applicable to all of the charging port(s) of the charging station(s) of the reservation group.

Flow then moves from operation 230 to operation 240 and the reservation group configuration module 150 transmits charging reservation group configuration information to appropriate ones of the charging stations. For example, the charging reservation group configuration information is transmitted to those charging stations that have charging ports that are part of the configured charging reservation group. In some embodiments, the charging reservation group configuration information is transmitted to one or more gateway devices, which may be one or more of the charging stations and/or a different device, that forwards the charging reservation group configuration information to the charging stations.

The charging reservation group configuration information may include one or more of the following: the pricing for the charging reservation group, a list of identifiers (e.g., charging station serial numbers) for those charging stations that are part of the charging reservation group, information that indicates how to communicate with the charging stations that are part of the charging reservation group (e.g., the IP addresses of the charging stations), and a list of identifiers that indicate which electric vehicle operators are allowed to use the charging station(s) of the charging reservation group. In one embodiment the charging stations install the charging reservation group configuration information received from the server 140. In some embodiments, the charging stations include a display that can indicate at least some of the charging reservation group configuration information (e.g., the price for a reservation, etc.).

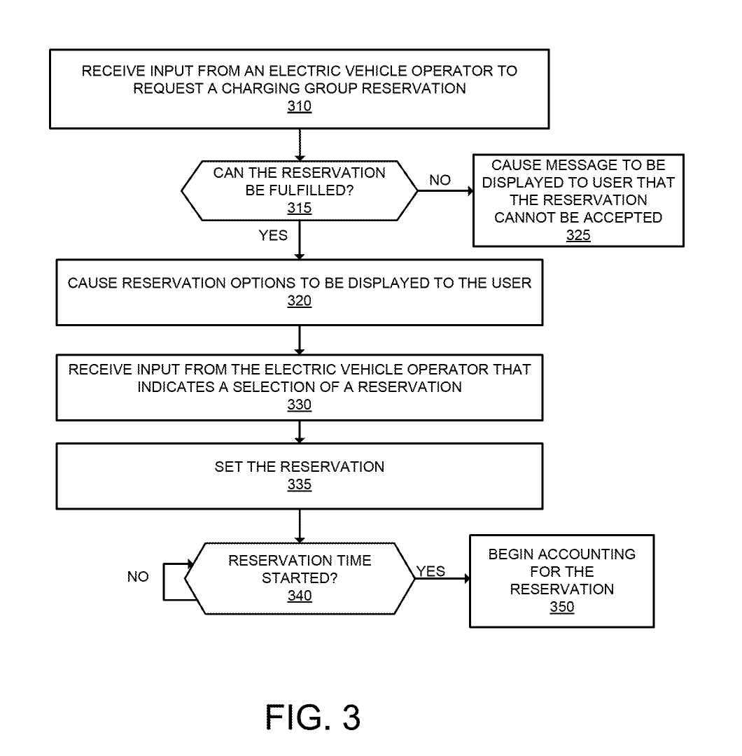

Sometime after a charging reservation group is configured, an electric vehicle operator 180 can establish a reservation for that charging reservation group. FIG. 3 is a flow diagram illustrating exemplary operations for making a charging group reservation according to one embodiment. The operations of FIG. 3 will be described with reference to the exemplary embodiment of FIG. 1. However, it should be understood that the operations of FIG. 3 can be performed by embodiments of the invention other than those discussed with reference to FIG. 1, and the embodiments discussed with reference to FIG. 1 can perform operations different than those discussed with reference to FIG. 3.

At operation 310, the reservation module 155 receives input from an electric vehicle operator 180, or on behalf of the electric vehicle operator 180, to request a charging group reservation. The electric vehicle operator 180 may access the reservation module 155 through the Internet using a web browser or through specialized application software that connects to the reservation module 155 (e.g., an application on a smartphone) to input the reservation request. In one embodiment, the input indicates a desired location of the charging (e.g., the input includes a zip code, city, neighborhood, landmark, recognizable building (e.g., airport, shopping center, theatre, etc.), street address, geolocation information associated with the IP address of the computing device sending the input, GPS coordinates provided by the computing device sending the input) and when the requested reservation is for (e.g., a date and/or time for the reservation). The input may also include other attributes including one or more of a maximum cost of the reservation, a particular host, a particular type of charging port, a duration of the reservation (e.g., X number of hours), and whether the reservation is to include come-and-go privileges. The input may also include information that identifies the electric vehicle operator 180 (e.g., an electric vehicle operator identifier). For example, the identifying information can include one or more of: an RFID tag associated with the electric vehicle operator, a username of the electric vehicle operator, an email address, a phone number, an address, a credit card number, an account number, a PIN (personal identification number), and a VIN (vehicle identification number) of an electric vehicle associated with the electric vehicle operator. In one embodiment, the electric vehicle operator 180 has an account on the server 140 and may be identified as a result of logging into the server 140. Flow moves from operation 310 to operation 315.

At operation 315, the reservation module 155 determines whether the reservation can be fulfilled. For example, the reservation module 155 determines whether the reservation can be fulfilled based on the input received from the electric vehicle operator 180, the parameters of any charging reservation groups that have been configured that include charging station(s) near the provided location, and the availability of those charging reservation groups for the requested time/date. In one embodiment the reservation module 155 analyzes the charging reservation groups belonging to all of the hosts 105A-L unless the input received in operation 310 indicates a reservation for a particular one of the hosts 105 (in which case the reservation module 155 limits its analysis of charging reservation group(s) associated with that host only). By way of example, if the electric vehicle operator requests a reservation of a charging station near the zip code 94085 for next Friday, the reservation module 155 determines whether there is a charging reservation group that includes one or more charging stations near the zip code 94085 and is available for a reservation for next Friday. It should be understood that there may be multiple charging reservation groups that can fulfill the reservation request.

If the reservation cannot be fulfilled, flow moves from operation 315 to operation 325 where the reservation module 155 causes a message to be sent and/or displayed to the electric vehicle operator 180 that indicates that the reservation cannot be fulfilled. The message may also provide the reason that the reservation cannot be fulfilled (e.g., a reservation cannot be made for that date/time in that location, etc.) and may suggest other locations and/or time and/or dates in which the reservation request could be fulfilled.

If the reservation can be fulfilled, flow moves from operation 315 to operation 320. At operation 320, the reservation module 155 causes one or more reservation options to be displayed to the electric vehicle operator 180 that indicate the charging reservation group(s) that match the conditions of the reservation request. The reservation options further can provide details of the charging reservation group(s) including the price of charging (including multiple prices if so configured), the location of the charging stations of the relevant charging reservation group(s) (e.g., a street address), an identity of the host belonging to the charging reservation group, ratings of the host belonging to the charging reservation group, etc. In one embodiment, the reservation options are overlaid onto an interactive map that allows the electric vehicle operator to view the charging stations of the matching charging reservation group(s). In some embodiments, the reservation module 155 prioritizes the results of the reservation request processing based on host priority. For example, the reservation module 155 may prioritize the charging reservation groups of those hosts that pay a premium for the reservation service. For example, the reservation module 155 can prioritize the display of the matching charging reservation groups based on the amount the corresponding hosts pay for the reservation service. Flow moves from operation 320 to operation 330.

At operation 330, the reservation module 155 receives input from the electric vehicle operator 180 that indicates a selection of a charging group reservation. For example, the electric vehicle operator 180 selects one of the charging stations in a charging reservation group or alternatively selects a charging reservation group itself to indicate a selection of a charging group reservation. The reservation module 155 may also receive payment information from the electric vehicle operator 180 (e.g., account information, credit card information, etc.).

An electric vehicle operator may be associated with an account on the server 140 that is also associated with other electric vehicle operators. For example, multiple family members may share an account on the server 140, each of which may be separately identified through a different identifier. For example, each family member may be issued a separate RFID card that contains a separate identifier. In such situations, the electric vehicle operator 180 may also specify that the charging group reservation is applicable for one or more other operators associated with the same account.

Flow moves from operation 330 to operation 335 where the reservation module 155 sets the reservation. In one embodiment, setting the reservation includes accounting for the reservation in the selected charging reservation group for the selected time and date as well as creating a reservation timer for the reservation. For example, this may include storing data that identifies and defines the reservation in the charging group reservation data store 165. For example, the data includes one or more of the following: the time/date of the reservation including starting time and ending time, price of the reservation, information identifying the electric vehicle operator(s) (e.g., one or more identifiers associated with one or more electric vehicle operators) that belong to the reservation, payment information, identifier(s) of the charging station(s) that are applicable to the reservation, whether come-and-go privileges are applicable, etc. In one embodiment, setting the reservation also includes sending reservation information to the charging station(s) of the charging reservation group corresponding to the reservation. In one embodiment, the reservation information includes one or more of the date and time of the reservation, an identifier associated with the electric vehicle operator, the pricing scheme to apply to the reservation, and whether the reservation includes come-and-go privileges. Flow moves from operation 335 to operation 340.

At operation 340, the reservation module 155 determines whether the reservation time has started for the electric vehicle operator. In some embodiments, the server 140 begins to bill or perform accounting for the electric vehicle operator upon the reservation time starting, regardless of whether the electric vehicle operator has driven their electric vehicle to the charging station and/or is charging their electric vehicle. In some embodiments, sometime before the reservation is going to start (e.g., 30 minutes, 60 minutes before the start time of the reservation), the reservation module 155 causes a message (e.g., email message, text message) to be sent to the electric vehicle operator 180 to alert the electric vehicle operator 180 that the reservation will be starting soon. If the reservation time has started, then flow moves to operation 350 and the server 140 begins accounting for the electric vehicle operator for the reservation. If the reservation time has not started, then flow moves to back to operation 340.

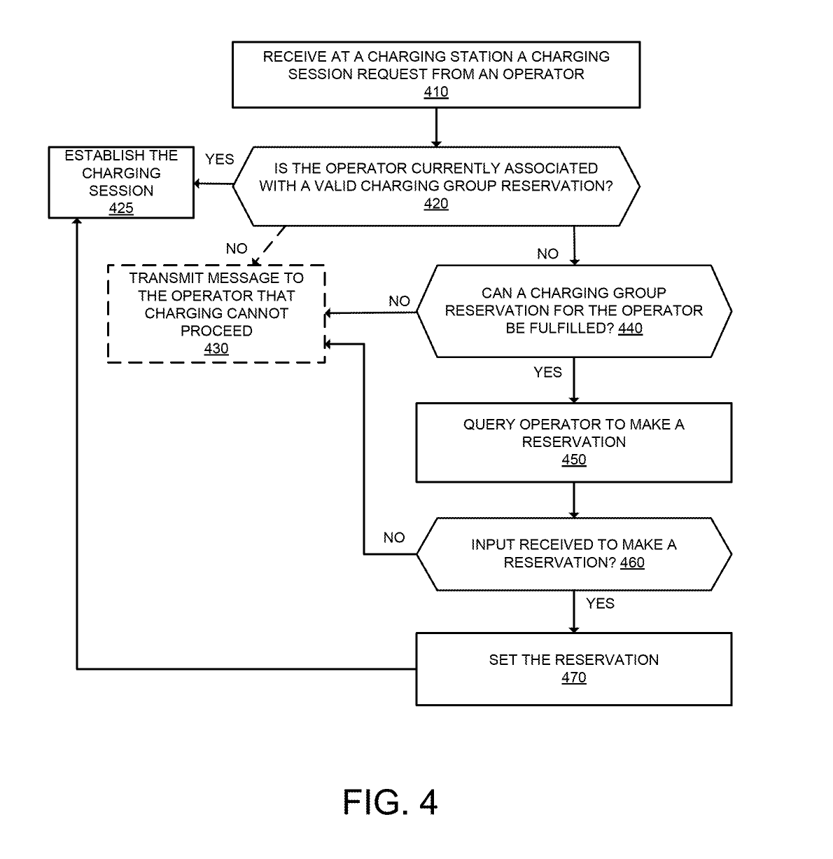

FIG. 4 is a flow diagram illustrating exemplary operations related to an electric vehicle operator using a charging station in conjunction with a charging group reservation and/or making a charging group reservation according to one embodiment. The operations of FIG. 4 will be described with reference to the exemplary embodiment of FIG. 1. However, it should be understood that the operations of FIG. 4 can be performed by embodiments of the invention other than those discussed with reference to FIG. 1, and the embodiments discussed with reference to FIG. 1 can perform operations different than those discussed with reference to FIG. 4.

At operation 410, a charging station 110 receives a request from one of the electric vehicle operators 180 for a charging session to be established to allow that electric vehicle operator to use an available charging port of that charging station 110. The electric vehicle operators 180 may request charging sessions in a number of different ways. For example, the electric vehicle operators 180 may use a mobile communication device (e.g., one or two-way radio-frequency identification (RFID) device, mobile computing device (e.g., laptops, palmtop, smartphone, multimedia mobile phone, cellular phone, etc.), ZigBee device, etc.) to communicate the request. For example, an electric vehicle operator 180 may waive or swipe an RFID card near the charging station to request a charging session. In some embodiments, the electric vehicle operators 180 can use a user interface on the electric vehicle charging station to request a charging session.

The request may also include information that identifies the electric vehicle operator. For example, the identifying information can include one or more of: an RFID tag associated with the electric vehicle operator, a username of the electric vehicle operator, an email address, a phone number, an address, a credit card number, an account number, a PIN (personal identification number), and a VIN (vehicle identification number) of an electric vehicle associated with the electric vehicle operator. The request may also indicate a particular charging port if the charging station 110 has multiple charging ports.

Typically the process for requesting a charging session includes an electric vehicle operator driving their electric vehicle to an electric vehicle charging station that is not currently connected to another electric vehicle, parking their vehicle in the charging station's associated parking space, and shortly thereafter requesting the charging session. However, even though a charging port of an electric vehicle charging station may appear to be available for charging if it is not currently connected to another electric vehicle, the charging port may be part of a charging reservation group and reserved for use. In one embodiment, if the charging port is part of a charging reservation group, the electric vehicle operator requesting the charging session will not be allowed to use the charging port and may also not be allowed to park in the charging station's associated parking space if the operator is not associated with a valid reservation for the charging reservation group at the time of the charging session request.

Flow moves from operation 410 to operation 420 where it is determined whether the electric vehicle operator making the charging session request is currently associated with a valid charging group reservation. A valid charging group reservation is an active reservation for a charging reservation group of which the charging port is a member.

In one embodiment, the server 140 determines whether the electric vehicle operator is currently associated with a valid charging group reservation. For example, the charging session request is transmitted to the server 140 (e.g., by the charging station 110) and the reservation module 155 determines whether the electric vehicle operator 180 is currently associated with a valid charging group reservation based on an electric vehicle operator identifier included or derived from the charging session request, an identification of the charging station and/or charging port, and the reservation information stored in the reservation data store 165. For example, based on the charging station identification and/or charging port identification, the reservation module 155 determines the charging reservation group of which the charging port is a member. The reservation module 155 then determines, based on the electric vehicle operator identifier included or derived from the charging session request, whether that electric vehicle operator is currently (e.g., substantially at the time of the request) associated with an outstanding charging group reservation for that charging group. The server 140 may also update the reservation information in the reservation data store 165 to indicate that the reservation is currently in use if the electric vehicle operator is associated with a valid charging group reservation. After making the determination, the server 140 transmits information to the charging station 110 that indicates whether the electric vehicle operator is associated with a valid charging group reservation.

In another embodiment, the charging station 110 determines whether the electric vehicle operator is currently associated with a valid charging group reservation. For example, the charging station 110 compares the electric vehicle operator identifier included in or derived from the charging session request against the reservation information that is received from the server 140 and/or other charging stations to determine whether the electric vehicle operator 180 is currently associated with a valid charging group reservation.

If the electric vehicle operator 180 is currently associated with a valid charging group reservation, then flow moves to operation 425 and a charging session is established. In one embodiment, establishing the charging session includes energizing the charging port to allow energy to be transferred between an electric vehicle and a power grid via the charging port. The reservation information in the reservation data store 165 is also updated to reflect that the reservation has been fulfilled. In some embodiments, the updated reservation information that reflects that the reservation has been fulfilled is also sent to the other charging station(s) of the charging reservation group (if there is any).

In some embodiments, a charging session will not be allowed for a particular electric vehicle operator unless the operator has already made a charging group reservation. In cases where the electric vehicle operator 180 is associated with an account that includes multiple operators (e.g., a family account), the reservation will not be valid if the reservation is already used and/or is currently in use (e.g., by a different operator associated with the same account). Therefore, in these embodiments, if the electric vehicle operator 180 is not currently associated with a valid charging group reservation, then flow moves to operation 430 and a message is transmitted or displayed to the electric vehicle operator that a charging session cannot be established. The message may also indicate that the charging session has been rejected because the user did not have a valid reservation.

In another embodiment, flow moves from operation 420 to operation 440 if the electric vehicle operator is not currently associated with a valid charging group reservation. At operation 440, a determination is made whether a charging group reservation for the charging group associated with the charging port of the charging station 110 can be currently made for the electric vehicle operator.

In one embodiment, the server 140 determines whether a charging group reservation can be set that starts at the current time for a predetermined duration. For example, the reservation module 155 determines whether adding a reservation to the charging group at the current time and any time during the predetermined duration would exceed the configured maximum number of reservations that the group supports (e.g., based on the number of reservations for the charging reservation group over the duration as indicated in the reservation data store 165 and the maximum number of reservations supported by that charging reservation group as indicated in the configuration data store 160). The reservation module 155 may also determine whether the electric vehicle operator is eligible for the reservation, which is performed if the charging reservation group is limited to certain electric vehicle operators. For example, the reservation module 155 may compare the electric vehicle operator identifier included in or derived from the charging session request with the identifier(s) that are allowed to make a reservation for the charging reservation group. In another embodiment, the charging station 110 determines whether a charging group reservation can be set that starts at the current time for a predetermined duration based on the reservation information and the reservation group configuration information received from the server 140.

If a reservation cannot be set, then flow moves to operation 430 and a message is transmitted or displayed to the electric vehicle operator that a charging session cannot be established. The message may also indicate that the charging session has been rejected because the user did not have a valid reservation and a reservation cannot be made. If a reservation can be set, then flow moves to operation 450.

At operation 450, the electric vehicle operator is queried whether to make a reservation. In one embodiment, the charging station 110 or a separate device (e.g., a payment station coupled with the charging station 110) displays an offer to the electric vehicle operator to make a reservation. The reservation offer may specify the price of the reservation, the duration of the reservation, the other charging station(s) (if any) that are part of the same charging reservation group, and whether the reservation includes come-and-go privileges or can include come-and-go privileges for an extra fee. Flow then moves to operation 460 where it is determined whether input has been received to make the reservation. If input has been received to make the reservation, then flow moves from operation 460 to operation 470, otherwise flow moves to operation 430. In one embodiment, the charging station 110 receives the input to set the reservation (and may forward the input to the server 140 and/or process the input locally).

At operation 470, the reservation is set. In an embodiment where the charging station 110 sets the reservation locally, the charging station 110 stores data of the reservation in a local charging reservation group data store to reflect the new reservation. For example, the reservation information indicates one or more of: the start date/time and optionally the end date/time of the reservation, the duration of the reservation, one or more electric vehicle operator identifier(s) associated with the reservation (e.g., an identifier belonging to the electric vehicle operator and optionally identifiers belonging to the same account as the electric vehicle operator), the pricing of the reservation, and whether come-and-go privileges are applied. In addition, the charging station 110 causes the reservation information that reflects the newly created reservation to be transmitted to the other charging stations in the charging reservation group (if there are any) and/or to the server 140. In one embodiment, the charging station 110 transmits the reservation information to the server 140 which then transmits the reservation information to the other charging stations in the charging reservation group, while in another embodiment the charging station 110 transmits the reservation information to the charging stations without use of the server 140. The reservation information includes one or more of: the start date/time of the reservation and optionally the end date/time of the reservation, the identifier(s) associated with the reservation, the pricing scheme to apply to the reservation, and whether come-and-go privileges are applicable. The other charging station(s) and/or server that receives the reservation information update their reservation information to reflect the addition of the reservation. In one embodiment, the charging station(s) that receive the reservation information and/or the server 140 respond with an acknowledgment message, and the charging station 110 retransmits the reservation information to those charging stations and/or the server that the charging station 110 has not received an acknowledgement from.

In another embodiment, the server 140 (e.g., the reservation module 155 of the server 140) sets the reservation. For example, the reservation module 155 causes data to be stored that identifies and defines the reservation in the charging group reservation data store 165. For example, the data includes one or more of the following: the time/date of the reservation including starting time and ending time, price of the reservation, a charging reservation group identifier, information identifying the electric vehicle operator(s) (e.g., one or more identifiers associated with one or more electric vehicle operators) that belong to the reservation, payment information, identifier(s) of the charging station(s) that are applicable to the reservation, whether come-and-go privileges are applicable, etc. In one embodiment, setting the reservation also includes sending reservation information to the charging station(s) of the charging reservation group corresponding to the reservation. In one embodiment, the reservation information includes one or more of the date and time of the reservation, an identifier associated with the electric vehicle operator, the pricing scheme to apply to the reservation, and whether the reservation includes come-and-go privileges.

In an alternative embodiment, instead of offering a reservation to the electric vehicle operator (e.g., at operation 450), the charging session is automatically established assuming that the electric vehicle operator is otherwise authorized to use that charging port and/or charging station and the reservation can be supported. However, this is effectively treated as a reservation for the charging reservation group. The other charging station(s) of the reservation group (if there are any) are updated to reflect the reservation. In one embodiment, the automatic reservation is for a predefined amount of time (e.g., 24 hours) and may be shortened when the charging session ends (e.g., when the electric vehicle is disconnected from the charging port).

In some embodiments, the charging group reservations can be extended. In one embodiment, reservations are extended only by explicit request of the electric vehicle operator. It should be understood that extending a charging group reservation may incur further charges for the electric vehicle operator.

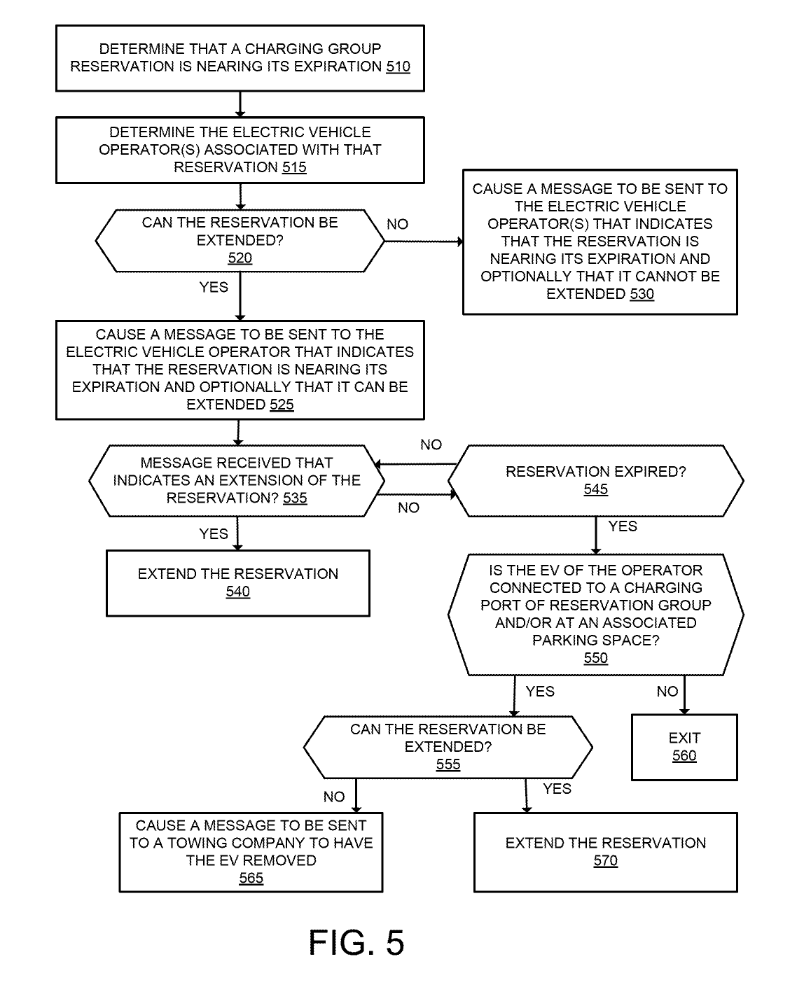

FIG. 5 is a flow diagram illustrating exemplary operations for extending charging group reservations according to one embodiment. The operations of FIG. 5 will be described with reference to the exemplary embodiment of FIG. 1. However, it should be understood that the operations of FIG. 5 can be performed by embodiments of the invention other than those discussed with reference to FIG. 1, and the embodiments discussed with reference to FIG. 1 can perform operations different than those discussed with reference to FIG. 5.

At operation 510, the reservation module 155 determines that a charging group reservation is nearing its expiration (e.g., nearing its stop time by an amount that may be configurable). Flow then moves to operation 515 and the reservation module 155 determines the electric vehicle operator(s) that are associated with the reservation that is nearing expiration. For example, the reservation module 155 accesses the reservation data store 165 to determine the electric vehicle operator(s) that are associated with the reservation. Next, flow moves to operation 520 and the reservation module 155 determines whether the reservation can be extended. For example, the reservation module 155 can determine whether the reservation can be extended based on the existing reservations for the charging group for the time period covering the extension and the total number of reservations that the charging group can support during that time. If the charging group reservation cannot be extended, then flow moves from operation 520 to operation 530 and the server 140 causes a message (e.g., text message, email message, etc.) to be sent to one or more of the electric vehicle operators associated with the expiring charging group reservation that indicates that the reservation is nearing its expiration. The message may also indicate that the reservation cannot be extended because the charging group cannot support an additional reservation. If the reservation can be extended, then flow moves from operation 520 to operation 525.

At operation 525, the reservation module 155 causes a message (e.g., text message, email message, etc.) to be sent to one or more of the electric vehicle operators associated with the expiring charging group reservation that indicates that the reservation is nearing its expiration. The message may also indicate that the reservation can be extended. The message may also query each of those electric vehicle operators to determine whether it wants to extend the reservation. For example, if the message is an email message, it may include a link that when selected by the electric vehicle operator, transmits a request to the server 140 to extend the reservation. The message may also indicate the price of the extension (which may be the same or different than the price of the original reservation), the duration of the extension, and/or whether the extension supports come-and-go privileges. Flow then moves to operation 535.

At operation 535, the reservation module 155 determines whether it receives a message that indicates that the electric vehicle operator requests extension of the reservation. The message may be received as a result of the electric vehicle operator selecting a link embedded in an email message sent to the electric vehicle operator to notify him/her of the expiring reservation. The message may also be a text message (e.g., the message being sent to a number that is dedicated for extending reservations) sent by or on behalf of the electric vehicle operator. The message may also be received as a result of the electric vehicle operator calling a telephone number associated with the registration service to extend the reservation. If a message indicating that the electric vehicle operator requests extension of the reservation is received, then flow moves from operation 535 to operation 540, otherwise flow moves to operation 545.

At operation 540, the reservation module 155 extends the reservation. In one embodiment, extending the reservation includes updating the stop time of the reservation and may include updating the pricing of the reservation if the pricing is different than the original reservation. In one embodiment, extending the reservation also includes sending updated reservation information to the charging station(s) in the corresponding charging reservation group, including one or more of the updated date/time of the reservation, the identifier(s) associated with the reservation, and the pricing scheme to apply to the reservation.

At operation 545, the reservation module 155 determines whether the reservation has expired. If the reservation has not expired, then flow moves back to operation 535. If the reservation is expired, then flow moves to operation 550 and the reservation module 155 determines whether an electric vehicle belonging to the electric vehicle operator(s) associated with the reservation is connected to a charging port of the charging reservation group of the expired reservation and/or is located in a parking space associated with a charging station of the charging reservation group. For example, the reservation module 155 may make this determination based on whether a charging session belonging to the reservation is active for any of the electric vehicle operator(s), and/or whether vehicle proximity information indicates that an electric vehicle used during the reservation is located in an associated parking space. If an electric vehicle belonging to the electric vehicle operator is connected to a charging port that belongs to the charging reservation group of the expired reservation and/or is located in an associated parking space, then flow moves to operation 555, otherwise flow moves to operation 560 where the operations exit.

At operation 555, the reservation module 155 determines whether the reservation can be extended. For example, the reservation module 155 can determine whether the reservation can be extended based on the existing reservations for the charging reservation group for the time period covering the extension and the total number of reservations that the charging reservation group can support during that time. If the reservation cannot be extended, then flow moves from operation 555 to operation 565 where the reservation module 155 causes a message to be sent to a towing company to have the electric vehicle towed. The message may indicate which charging station and/or which parking space the electric vehicle is located in. The reservation module 155 may also transmit a message to the charging station that is connected to the electric vehicle and/or associated with the parking space the electric vehicle that causes that charging station to display an indication of violation, which may be useful for a towing company to locate the electric vehicle in violation.

If the reservation can be extended, then flow moves from operation 555 to operation 570 where the reservation module 155 automatically extends the reservation for a predefined amount of time (which may be predefined by the host or by the electric vehicle operator). This may include updating the stop time of the reservation and may also include updating the pricing of the reservation if the pricing is different than the original reservation. In one embodiment, extending the reservation also includes sending updated reservation information to the charging station(s) in the charging reservation group, including one or more of the updated date/time of the reservation, an identifier associated with the electric vehicle operator, and the pricing scheme to apply to the reservation.

While FIG. 5 was described in reference to the operations being performed on the server 140, in other embodiments of the inventions similar operations can be performed locally on a charging station.

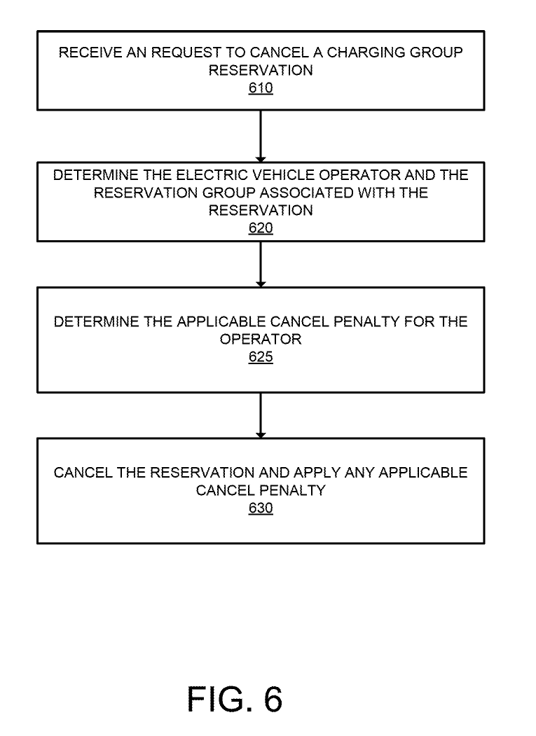

In some embodiments, charging group reservations may be cancelled. FIG. 6 is a flow diagram illustrating exemplary operations for cancelling a charging group reservation according to one embodiment.

At operation 610, the reservation module 155 receives a request from or on behalf of an electric vehicle operator to cancel a charging group reservation. Flow then moves to operation 620 and the reservation module 155 identifies the electric vehicle operator and the charging reservation group associated with the reservation based on information included in the request. For example, assuming that the requests includes an identifier associated with the electric vehicle operator or other information that identifies the electric vehicle operator, the reservation module 155 looks up the existing reservation associated with that electric vehicle operator. Flow then moves to operation 625.

At operation 625, the reservation module 155 determines the applicable penalty (if any) for cancelling the reservation for the electric vehicle operator. As previously described, when configuring a charging reservation group, a host may indicate a cancel interval that indicates an amount of time before the reservation is set to begin before which an electric vehicle operator can cancel the reservation without penalty. The host may also indicate the penalty amount during the configuration. In one embodiment, if there is a penalty, the reservation module 155 causes a message to be displayed or sent to the electric vehicle operator(s) associated with the reservation that indicates the penalty amount and requests confirmation of the cancellation. Flow then moves to operation 630 and the reservation module 155 cancels the reservation and applies the applicable cancel penalty (e.g., bills the electric vehicle operator for the cancellation, deducts from the account of the electric vehicle operator, etc.). In one embodiment, as part of the cancellation, the reservation module 155 updates its reservation information stored in the reservation data store 165 and/or sends updated reservation information to the charging station(s) of the charging reservation group that was associated with the reservation that was cancelled.

While FIG. 6 is described in reference to the operations being performed on the server 140, in other embodiments of the inventions similar operations can be performed locally on a charging station. For example, the charging station can cancel the reservation and cause updated reservation information to be sent to each of the other charging station(s) of the charging reservation group.

FIG. 7 illustrates an exemplary embodiment of a charging station according to one embodiment of the invention. It should be understood that FIG. 7 illustrates an exemplary architecture of a charging station, and other, different architectures may be used in embodiments of the invention described herein.

As illustrated in FIG. 7, the charging station 700 includes the energy meter 710, the current control device 715, the charging port 720, the volatile memory 725, the non-volatile memory 730 (e.g., hard drive, flash, PCM, etc.), one or more transceiver(s) 735 (e.g., wired transceiver(s) (e.g., Ethernet, power line communication (PLC), etc.) and/or wireless transceiver(s) (e.g., 802.15.4 (e.g., ZigBee, etc.), Bluetooth, WiFi, Infrared, GPRS/GSM, CDMA, etc.)), the RFID reader 740, the display unit 745 (which is optional), the user interface 750 (which is optional), and the processing system 755 (e.g., one or more microprocessors and/or a system on an integrated circuit), which are coupled with one or more buses 760. In one embodiment, the reservation group configuration information and the reservation information is stored in the non-volatile memory 730 and/or the volatile memory 725.

The energy meter 710 measures the amount of electricity that is flowing on the power line 705 through the charging port 720. While in one embodiment of the invention the energy meter 710 measures current flow, in an alternative embodiment of the invention the energy meter 710 measures power draw. The energy meter 710 may be an induction coil or other devices suitable for measuring electricity. In some embodiments, the energy meter 710 is a programmable time of use energy meter (e.g., programmed according to the prices and time periods defined by its host).

The charging port 720 is a power receptacle or circuitry for an attached charging cord (e.g., with a SAE J1772 connector). The power receptacle can be any number of types of receptacles such as receptacles conforming to the NEMA (National Electrical Manufacturers Association) standards 5-1 5, 5-20, and 14-50 or other standards (e.g., BS 1363, CEE7, etc.) and may be operating at different voltages (e.g., 120V, 240V, 230V, etc.).

The current control device 715 is a solid-state device that is used to control the current flowing on the power line 705 or any other device suitable for controlling the current flowing on the power line 705. For example, in some embodiments the current control device 715 energizes the charging port 720 (e.g., by completing the circuit to the power line 705) or de-energizes the charging port 720 (e.g., by breaking the circuit to the power line 705). In some embodiments the current control device 715 energizes the charging port 720 responsive to a determination that an electric vehicle operator that is requesting a charging session has a valid reservation to use the charging station 700.

The RFID reader 740 reads RFID tags from RFID enabled devices (e.g., smartcards, key fobs, contactless credit cards, etc.), embedded with RFID tag(s) of operators that want to use the charging station 700. For example, in some embodiments a vehicle operator can wave/swipe an RFID enabled device near the RFID reader 730 to request a charging session with the charging station 700. It should be understood, however, that charging sessions may be requested in different ways and access identifiers may be presented to the charging station in different ways. For example, in some embodiments the electric vehicles communicate an access identifier (e.g., their VIN) to the charging station through a protocol (e.g., PLC). In such embodiments, the electric vehicle operator may not be required to present an access identifier (such as the RFID enabled device) to gain access to the charging station. However, it should be understood that the electric vehicle operators may use the RFID reader 740 for payment. In addition to an RFID reader, the charging station 700 may also include a credit card reader.

The transceiver(s) 735 transmit and receive messages. For example, the transceiver(s) 735 receive pricing specifications from the server, transmit authorization requests to the server, transmit charging session data to the server for accounting, etc. The display unit 745 is used to display messages to vehicle operators including the price(s) for charging service, current cost for charging service, charging status, confirmation messages, error messages, notification messages, etc. The display unit 745 may also display parking information if the charging station 700 is also acting as a parking meter (e.g., amount of time remaining in minutes, parking violation, etc.).

The user interface 740 (which is optional) allows users to interact with the charging station 700. By way of example, the user interface 750 allows electric vehicle operators to request charging sessions, request reservations, cancel reservations, extend reservations, pay for charging sessions, enter in account and/or payment information, etc.

The processing system 755 may retrieve instruction(s) from the volatile memory 725 and/or the nonvolatile memory 730, and execute the instructions to perform operations as described above.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., a charging station, a charging station network server, etc.). Such electronic devices store and communicate (internally and/or with other electronic devices over a network) code and data using machine-readable media, such as non-transitory machine-readable storage media (e.g., magnetic disks; optical disks; random access memory; read only memory; flash memory devices; phase-change memory) and transitory machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more non-transitory machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in an electric vehicle charging network server for establishing electric vehicle charging reservation groups, wherein the electric vehicle charging network server is coupled with a plurality of electric vehicle charging stations that each include one or more charging ports and are owned by a charging station host, the method comprising:
receiving input from the charging station host to configure an electric vehicle charging reservation group; and
configuring the electric vehicle charging reservation group according to the received input, wherein the configured electric vehicle charging reservation group includes a plurality of charging ports and wherein the configured electric vehicle charging reservation group allows a limited number of a plurality of electric vehicle charging group reservations that are each applicable to all of the plurality of charging ports that are part of the configured electric vehicle charging reservation group.

2. The method of claim 1, wherein the charging station host owns or operates the electric vehicle charging network server.

3. The method of claim 1, wherein the plurality of electric vehicle charging stations include the plurality of charging ports that are part of the configured electric vehicle charging reservation group.

4. The method of claim 1, wherein the received input further indicates that the electric vehicle charging reservation group includes come-and-go privileges

5. The method of claim 1, wherein the input received from the electric vehicle host further indicates a pricing scheme for the electric vehicle charging reservation group.

6. The method of claim 1, wherein the input received from the electric vehicle host further indicates which ones of a plurality of electric vehicle operators are allowed to make an electric vehicle charging group reservation for the electric vehicle charging reservation group.

7. The method of claim 1, further comprising:
receiving input from an electric vehicle operator that requests a charging group reservation for the electric vehicle charging reservation group;
responsive to determining that the charging group reservation for the electric vehicle charging reservation group can be fulfilled, setting the charging group reservation.

8. The method of claim 7, further comprising:
responsive to determining that the charging group reservation is nearing its expiration, sending a message to the electric vehicle operator that indicates that the charging group reservation is nearing its expiration.

9. The method of claim 7, further comprising:
wherein the input received from the electric vehicle operator to request the charging group reservation indicates a requested location and a requested time, and wherein determining that the charging group reservation can be fulfilled includes determining that electric vehicle charging reservation group includes at least one of the plurality of charging ports that is substantially near the requested location and supports a charging group reservation at the requested time.

10. The method of claim 7, further comprising:
receiving a request to allow an electric vehicle operator to use one of the plurality of charging ports that are part of the electric vehicle charging reservation group;
responsive to determining that the electric vehicle operator is associated with a valid charging group reservation for the electric vehicle charging reservation group, transmitting information to the electric vehicle charging station that includes the one of the plurality of ports, the information indicating that the charging session request is authorized to cause that electric vehicle charging station to allow charging.

11. A method in an electric vehicle charging station, comprising:
receiving a first request to use a charging port of the electric vehicle charging station from a first electric vehicle operator;
determining that the first electric vehicle operator is currently associated with a valid electric vehicle charging group reservation that is applicable to the charging port, wherein the charging port is one of a plurality of charging ports of an electric vehicle charging reservation group that has been configured to allow a limited number of electric vehicle charging group reservations that are each applicable to all of the plurality of charging ports that are part of the electric vehicle charging reservation group; and
establishing a charging session to allow energy to be transferred between an electric vehicle and a power grid through the charging port.

12. The method of claim 11, further comprising:
receiving reservation information for a plurality of electric vehicle charging group reservations, wherein for each electric vehicle charging group reservation, the reservation information indicates the following:
a date and time of that electric vehicle charging group reservation, and
a set of one or more identifiers that belong to that electric vehicle charging group reservation and identify one or more electric vehicle operators associated with that electric vehicle charging group reservation.

13. The method of claim 12, wherein determining that the first electric vehicle operator is currently associated with a valid electric vehicle charging group reservation that is applicable to the charging port includes determining that the first request includes one of the set of identifiers included in the reservation information and that the request is received during the corresponding date and time included in the reservation information.

14. The method of claim 12, further comprising:
receiving a second request to use the charging port from a second electric vehicle operator, wherein the second request is received after the charging session has been completed; and
responsive to determining that second electric vehicle operator is not currently associated with a valid electric vehicle charging group reservation that is applicable to the charging port, performing the following:
determining that an electric vehicle charging group reservation can be made for the electric vehicle charging reservation group at the current time, and
providing a reservation option to the second electric vehicle operator for the electric vehicle charging reservation group.

15. The method of claim 14, wherein the plurality of charging ports that are part of the electric vehicle charging reservation group are on a plurality of electric vehicle charging stations, and further comprising:
responsive to receiving input from the second electric vehicle operator to set an electric vehicle charging group reservation that is applicable for the charging port in response to the reservation option, performing the following:
setting the charging group reservation, and
causing reservation information that reflects that electric vehicle charging group reservation to be transmitted to those other ones of the plurality of electric vehicle charging stations that do not include the charging port.

16. A non-transitory machine-readable storage medium that provides instructions that, when executed by a processor, will cause said processor to perform operations comprising:
receiving input from a charging station host to configure an electric vehicle charging reservation group,
configuring the electric vehicle charging reservation group according to the received input, wherein the configured electric vehicle charging reservation group includes a plurality of charging ports, and wherein the configured electric vehicle charging reservation group allows a limited number of a plurality of electric vehicle charging group reservations that are each applicable to all of the plurality of charging ports that are part of the configured electric vehicle charging reservation group.

17. The non-transitory machine-readable storage medium of claim 16, wherein the charging station host owns or operates the electric vehicle charging network server.

18. The non-transitory machine-readable storage medium of claim 16, wherein the plurality of charging ports that are part of the configured electric vehicle charging reservation group are included in a plurality of electric vehicle charging stations.

19. The non-transitory machine-readable storage medium of claim 16, wherein the received input further indicates that the electric vehicle charging reservation group includes come-and-go privileges

20. The non-transitory machine-readable storage medium of claim 16, wherein the input received from the electric vehicle host further indicates a pricing scheme for the electric vehicle charging reservation group.

21. The non-transitory machine-readable storage medium of claim 16, wherein the input received from the electric vehicle host further indicates which ones of a plurality of electric vehicle operators are allowed to make an electric vehicle charging group reservation for the electric vehicle charging reservation group.

22. The non-transitory machine-readable storage medium of claim 16, further comprising:
receiving input from an electric vehicle operator that requests a charging group reservation for the electric vehicle charging reservation group;
responsive to determining that the charging group reservation for the electric vehicle charging reservation group can be fulfilled, setting the charging group reservation.

23. The non-transitory machine-readable storage medium of claim 22, further comprising:
responsive to determining that the charging group reservation is nearing its expiration, sending a message to the electric vehicle operator that indicates that the charging group reservation is nearing its expiration.

24. The non-transitory machine-readable storage medium of claim 22, further comprising:
wherein the input received from the electric vehicle operator to request the charging group reservation indicates a requested location and a requested time, and wherein determining that the charging group reservation can be fulfilled includes determining that electric vehicle charging reservation group includes at least one of the plurality of charging ports that is substantially near the requested location and supports a charging group reservation at the requested time.

25. The non-transitory machine-readable storage medium of claim 22, further comprising:
receiving a request to allow an electric vehicle operator to use one of the plurality of charging ports that are part of the electric vehicle charging reservation group;
responsive to determining that the electric vehicle operator is associated with a valid charging group reservation for the electric vehicle charging reservation group, transmitting information to the electric vehicle charging station that includes the one of the plurality of ports, the information indicating that the charging session request is authorized to cause that electric vehicle charging station to allow charging.

26. A non-transitory machine-readable storage medium that provides instructions that, when executed by a processor of an electric vehicle charging station, will cause said processor to perform operations comprising:
receiving a first request to use a charging port of the electric vehicle charging station from a first electric vehicle operator;
determining that the first electric vehicle operator is currently associated with a valid electric vehicle charging group reservation that is applicable to the charging port, wherein the charging port is one of a plurality of charging ports of an electric vehicle charging reservation group that has been configured to allow a limited number of electric vehicle charging group reservations that are each applicable to all of the plurality of charging ports that are part of the electric vehicle charging reservation group; and
establishing a charging session to allow energy to be transferred between an electric vehicle and a power grid through the charging port.

27. The non-transitory machine-readable storage medium of claim 26, further comprising:
receiving reservation information for a plurality of electric vehicle charging group reservations, wherein for each electric vehicle charging group reservation, the reservation information indicates the following:
a date and time of that electric vehicle charging group reservation, and
a set of one or more identifiers that belong to that electric vehicle charging group reservation and identify one or more electric vehicle operators associated with that electric vehicle charging group reservation.

28. The non-transitory machine-readable storage medium of claim 27, wherein determining that the first electric vehicle operator is currently associated with a valid electric vehicle charging group reservation that is applicable to the charging port includes determining that the first request includes one of the set of identifiers included in the reservation information and that the request is received during the corresponding date and time included in the reservation information.

29. The non-transitory machine-readable storage medium of claim 27, further comprising:
receiving a second request to use the charging port from a second electric vehicle operator, wherein the second request is received after the charging session has been completed; and
responsive to determining that second electric vehicle operator is not currently associated with a valid electric vehicle charging group reservation that is applicable to the charging port, performing the following:
determining that an electric vehicle charging group reservation can be made for the electric vehicle charging reservation group at the current time, and
providing a reservation option to the second electric vehicle operator for the electric vehicle charging reservation group.

30. The non-transitory machine-readable storage medium of claim 29, wherein the plurality of charging ports that are part of the electric vehicle charging reservation group are on a plurality of electric vehicle charging stations, and further comprising:
responsive to receiving input from the second electric vehicle operator to set an electric vehicle charging group reservation that is applicable for the charging port in response to the reservation option, performing the following:
setting the charging group reservation, and
causing reservation information that reflects that electric vehicle charging group reservation to be transmitted to those other ones of the plurality of electric vehicle charging stations that do not include the charging port.
